(19) United States
(12) Patent Application Publication
(10) Pub. No.: US 2024/0062015 A1
(43) Pub. Date: Feb. 22, 2024

(54) NATURAL LANGUAGE PROCESSING FOR DESCRIPTIVE LANGUAGE ANALYSIS

(71) Applicant: The United States of America, as represented by the Secretary of the Navy, Crane, IN (US)

(72) Inventor: Alicia L Scott, El Segundo, CA (US)

(73) Assignee: The United States of America, as represented by the Secretary of the Navy, Arlington, VA (US)

(21) Appl. No.: 18/226,297

(22) Filed: Jul. 26, 2023

Related U.S. Application Data
(63) Continuation of application No. 17/157,122, filed on Jan. 25, 2021, now Pat. No. 11,755,842.
(60) Provisional application No. 62/964,837, filed on Jan. 23, 2020.

(51) Int. Cl. G06F 40/30; G06F 40/226; G06F 40/284

(52) U.S. Cl. CPC G06F 40/30; G06F 40/226; G06F 40/284

(57) ABSTRACT

The present invention relates to methods and systems that use natural language processing (NLP) to read data from a file and analyze the data based on user defined parameters. According to an illustrative embodiment of the present disclosure, a system can process and analyze a data file by finding trending themes across data entries. According to a further illustrative embodiment of the present disclosure, the system can search for reoccurring or repeated words/phrases based on Ngrams (i.e., n-grams). The system can be adapted to search for Ngrams of varying length depending on the information sought and can sort the results by Ngram length.

### CROSS REFERENCE TO RELATED APPLICATIONS

The present application is a continuation of U.S. patent application Ser. No. 17/157,122 filed on Jan. 25, 2021, which claims the benefit of and priority to U.S. Provisional Application Ser. No. 62/964,837 filed on Jan. 23, 2020, the disclosures of which are expressly incorporated herein by reference.

### STATEMENT REGARDING FEDERALLY SPONSORED RESEARCH OR DEVELOPMENT

The invention described herein was made in the performance of official duties by employees of the Department of the Navy and may be manufactured, used and licensed by or for the United States Government for any governmental purpose without payment of any royalties thereon. This invention (Navy Case 200631US03) is assigned to the United States Government and is available for licensing for commercial purposes. Licensing and technical inquiries may be directed to the Technology Transfer Office, Naval Surface Warfare Center Crane, email: Crane_T2@navy.mil.

### FIELD OF THE INVENTION

The present invention relates to a system for processing and analyzing data.

### BACKGROUND AND SUMMARY OF THE INVENTION

The present invention relates to a system that uses natural language processing (NLP) to read data from a file and analyze the data based on user defined parameters. When presented with a data file of potentially unknown or unfamiliar format, users have to manually read hundreds of lines of data to deduce information from a text entry description. For large and complicated files, this can take weeks of effort and time. This can also be prone to bias in trend only looking for the certain types of information. What is needed is an automated process to remove manual processing as well as give analytical results to assist a user in evaluating the data.

According to an illustrative embodiment of the present disclosure, a system can process and analyze a data file by finding trending themes across data entries. Exemplary embodiments are agnostic for type of data evaluated. The system works best with column and cell based data format where it can derive themes from separated text description entries.

According to a further illustrative embodiment of the present disclosure, the system can search for reoccurring words/phrases based on Ngrams (i.e., n-grams). The system can be adapted to search for Ngrams of varying length depending on the information sought and can sort the results by Ngram length.

Additional features and advantages of the present invention will become apparent to those skilled in the art upon consideration of the following detailed description of the illustrative embodiment exemplifying the best mode of carrying out the invention as presently perceived.

### BRIEF DESCRIPTION OF THE DRAWINGS

The detailed description of the drawings particularly refers to the accompanying figures in which:

FIG. 1 shows an overview of the process steps for an exemplary system.

FIG. 2 shows an exemplary breakdown of the NLP functions.

FIG. 3 shows an exemplary text segment undergoing NLP.

FIG. 4 shows an exemplary text segment undergoing NLP.

FIG. 5 shows an exemplary data segment after NLP.

### DETAILED DESCRIPTION OF THE DRAWINGS

The embodiments of the invention described herein are not intended to be exhaustive or to limit the invention to precise forms disclosed. Rather, the embodiments selected for description have been chosen to enable one skilled in the art to practice the invention.

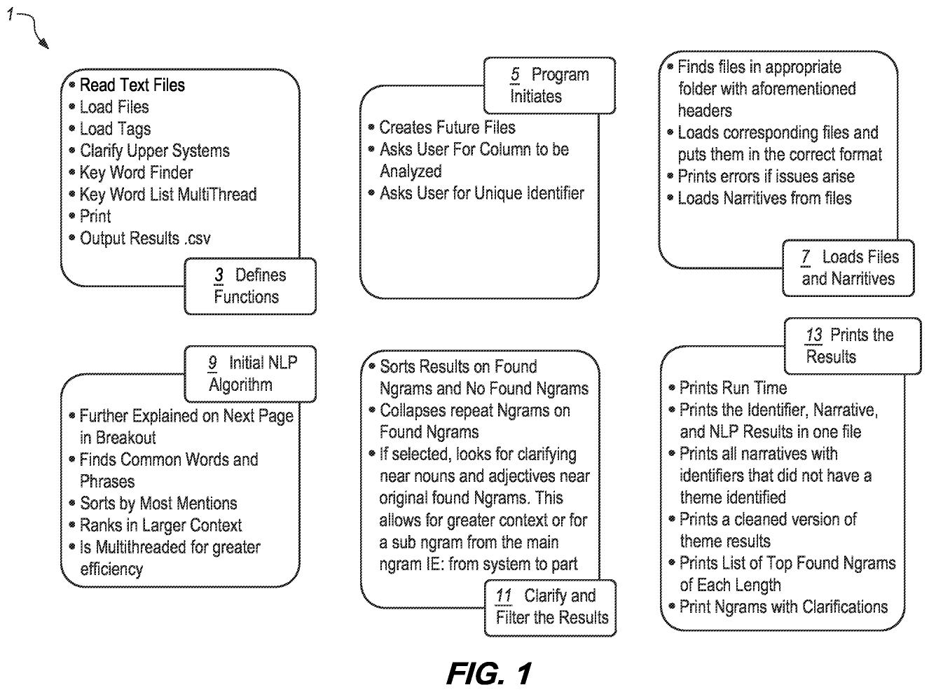

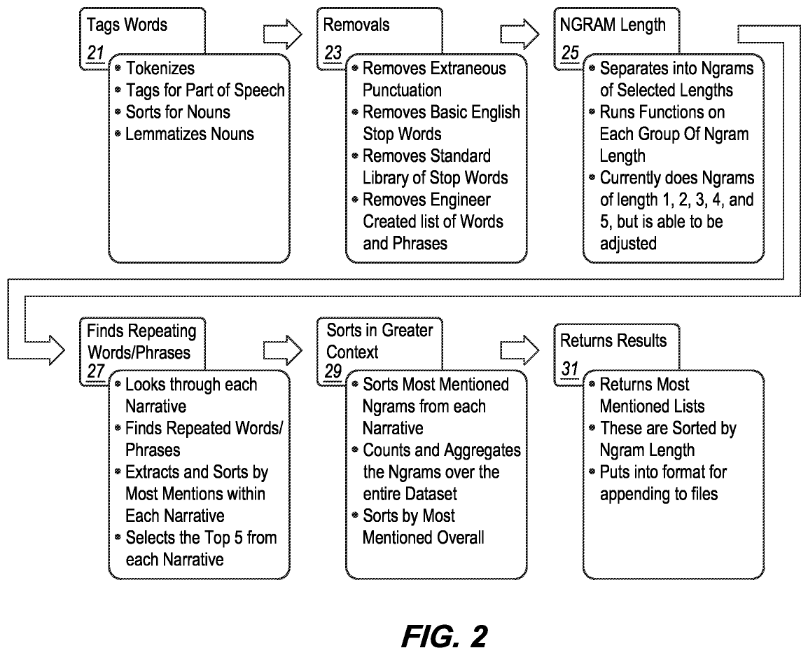

FIG. 1 shows an overview of the process steps for an exemplary system 1. At 3, the system defines the functions that will be used. At 5, the system initiates. As part of this step, the system asks a user to specify a column to be analyzed (i.e., a narrative column identified by a narrative tag) and an identifier tag that identifies a particular file. The narrative column should be where descriptive text is located so that the system has the greatest chance of finding meaningful text. At 7, the system loads files and narratives. As part of this step, the system searches for files marked with the identifier tag, searches for columns marked with the narrative tag within the identified files, and extracts the narratives for processing. At 9, the system runs a first set of NLP algorithms (e.g., as shown in FIG. 2) on the narratives. This step includes finding common words or phrases, sorting the words of phrases by most mentions, and ranking the words or phrases by context. At 11, the system clarifies and filters the results. As part of the step, the system sorts any Ngrams found, collapses the results for repeat Ngrams, and optionally searches for clarifying nouns and adjectives near the found Ngrams in the original text. By searching for clarifying nouns and adjectives, a user can identify potential causes or issues related to the original search topic. At 13, the system outputs the results. As part of this step, the system can write the identifier tag, narrative, and NLP results to an output file. The consolidated nature of the output file allows a user to quickly and easily see the results of the system without needing to view or sort superfluous information.

FIG. 2 shows an exemplary breakdown of the NLP functions. At 21, the system tags words by tokenizing the text, tagging sections of text based on type (e.g., noun, verb, etc.), and lemmatizes nouns. At 23, the system removes various text, including removal of extraneous punctuation, removal of basic stop words (e.g., the, a, and), removal of a list of stop words (e.g., words that are known to be stop words based on the context), and removal of a user created list of stop words (e.g., user defined words that may be expected). At 25, the system separates the text into groups based on Ngram length. At 27, the system searches for repeating words/phrases in the text, extracts and sorts the words/phrases by most mentions within a particular entry, and selects a predetermined number (e.g., higher number if large entries) of words/phrases from each entry. By not limiting the search to predetermined words/phrases specific to the context, a user can also find trending themes. These found trending themes can mitigate the bias by a human who is only looking for expected types of words/phrases. At 29, the system sorts the results across all of the entries, including sorting by most mentioned Ngrams from each entry, counting and aggregating the Ngrams across the entire dataset, and sorting by the most mentioned Ngrams throughout the entire dataset. At 31, the system returns the results including lists of most mentioned Ngrams sorted by Ngram length and outputs the results into a format for appending to files (e.g., adding an additional column in the original data file that lists the most reoccurring Ngrams for each row).

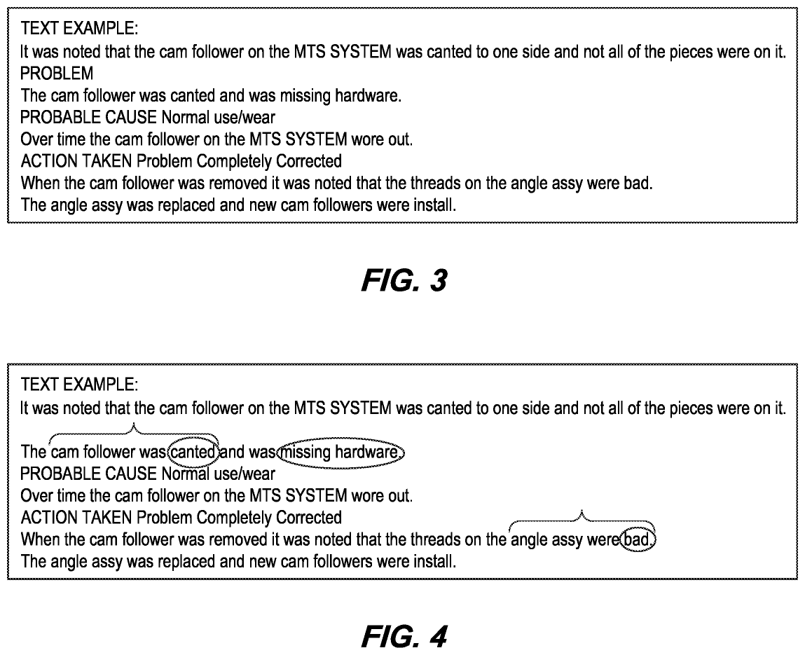

FIG. 3 shows an exemplary text segment undergoing NLP. In this example, “was” is identified as a basic stop word and will be removed from the analysis. “Problem” and “MTS SYSTEM” are context specific stop words that are expected to be in every entry, so they are removed from the analysis. The system then retrieves words/phrases with multiple mentions (“cam follower” and “angle assy”), which can then be sorted by most mentions and ranked in the larger context of the total data entries.

FIG. 4 shows an exemplary text segment continuing the NLP of FIG. 3. The system identifies connected noun/adjective phrases related to the previously identified words/phrases. The system creates an analysis file with a unique name, narrative field, and results of the NLP process. The system also creates a file of data entries that need manual intervention (e.g., no words/phrases were identified, no themes generated, etc.), and collapses the results within the analysis file.

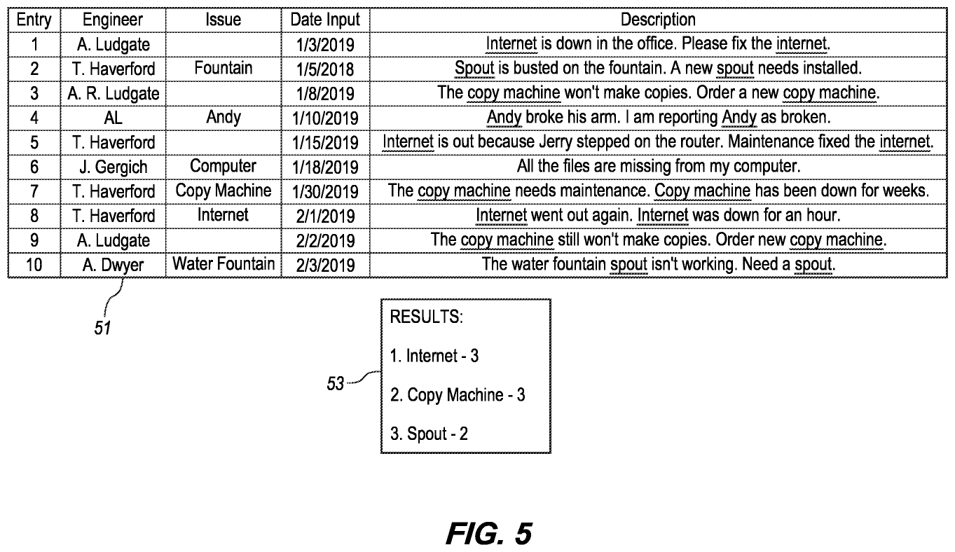

FIG. 5 shows an exemplary data segment 51 after NLP. The system the retrieves words/phrases with multiple mentions (“internet,” “copy machine,” and “spout”), which are then sorted by most mentions and ranked in the larger context of the total data entries under the results 53. If a user discovers a word/phrase that is not related the intended purpose of the search, the user can add the word/phrase to the list of stop words (e.g., see FIG. 2). Words phrases not meeting a particular threshold (e.g., reoccurring across multiple data entries) can be excluded from the results (e.g., “Andy”) to limit the results to words/phrases of higher importance.

Although the invention has been described in detail with reference to certain preferred embodiments, variations and modifications exist within the spirit and scope of the invention as described and defined in the following claims.

1. A method of processing textual data using natural language processing (NLP), the method comprising:
reading data from at least one data file including a plurality of textual data entries;
processing the plurality of textual data entries including one or more of removing word cases and punctuation, lemmatizing nouns, removing a first category of stop words, and removing a second category of stop words including thematic or data file specific stop words and phrases; and
applying natural language processing (NLP) to each of the processed plurality of textual data entries including:
identifying word level n-grams for one or more selectable word level n-gram lengths;
counting repeated n-gram instances among the identified word level n-grams within each textual data entry;
counting numbers of each of the repeated n-gram instances occurring across the plurality of textual data entries in the at least one data file; and
sorting the repeated n-grams instances based on the counted numbers of repeated n-gram instances occurring across the plurality of data entries to determine a most mentioned list of repeated n-gram instances for the at least one data file that is indicative of trending themes occurring across the textual data in the at least one data file.

2. The method of claim 1, further comprising:
outputting results of application of NLP to the plurality of processed textual data entries to an output analysis data file, the results including at least the most mentioned list.

3. The method of claim 2, wherein the output analysis data file further includes information concerning a data narrative column pertaining to the results of the application of NLP to the plurality of textual data entries.

4. The method of claim 1, wherein each of the plurality of textual data entries comprises a separate cell within the at least one data file.

5. The method of claim 4, wherein each of the separate cells are part of a same data narrative column within the at least one data file.

6. The method of claim 1, wherein sorting the repeated n-grams instances based on the counted numbers of repeated n-gram instances occurring across the plurality of data entries includes searching for nouns and adjectives near each identified n-gram in a textual data entry of the plurality of textual data entries pertaining to the identified n-gram.

7. The method of claim 1, wherein the most mentioned list comprises an ascending order list starting from a largest number of repeated n-gram instances for the at least one data file.

8. The method of claim 1, wherein the most mentioned list includes only repeated n-gram instances having counts above a predetermined number.

9. The method of claim 1, wherein the first category of stop words comprises at least one of basic stop words or stops words derived from a library

10. A textual data processing system using natural language processing (NLP), the processing system comprising:
a non-transitory computer readable storage medium operable for storing a plurality of machine readable computer instructions operable to control one or more elements of an NLP system comprising:
a first portion of machine readable computer instructions configured to read data from at least one data file including a plurality of textual data entries;
a second portion of machine readable computer instructions configured to process the plurality of textual data entries including one or more of removing word cases and punctuation, lemmatizing nouns, removing a first category of stop words, and removing a second category of stop words including thematic or data file specific stop words and phrases; and
a third portion of machine readable computer instructions configured to apply natural language processing (NLP) to each of the processed plurality of textual data entries including:
instructions configured to identify word level n-grams for one or more selectable word level n-gram lengths;
instructions configured to count repeated n-gram instances among the identified word level n-grams within each textual data entry;
instructions configured to count numbers of each of the repeated n-gram instances occurring across the plurality of textual data entries in the at least one data file; and
instructions configured to sort the repeated n-grams instances based on the counted numbers of repeated n-gram instances occurring across the plurality of data entries to determine a most mentioned list of repeated n-gram instances for the at least one data file that is indicative of trending themes occurring across the textual data in the at least one data file.

11. The system of claim 10, further comprising:
a fourth portion of machine readable computer instructions configured to output results of application of NLP to the plurality of processed textual data entries to an output analysis data file, the results including at least the most mentioned list.

12. The system of claim 11, wherein the output analysis data file further includes information concerning a data narrative column pertaining to the results of the application of NLP to the plurality of textual data entries.

13. The system of claim 10, wherein each of the plurality of textual data entries comprises a separate cell within the at least one data file.

14. The system of claim 13, wherein each of the separate cells are part of a same data narrative column within the at least one data file.

15. The system of claim 10, wherein the instructions configured to sort the repeated n-grams instances based on the counted numbers of repeated n-gram instances occurring across the plurality of data entries includes instructions configured to search for nouns and adjectives near each identified n-gram in a textual data entry of the plurality of textual data entries pertaining to the identified n-gram.

16. The system of claim 10, wherein the most mentioned list comprises an ascending order list starting from a largest number of repeated n-gram instances for the at least one data file.

17. The system of claim 10, wherein the most mentioned list includes only repeated n-gram instances having counts above a predetermined number.
